(19) United States
(12) Patent Application Publication
(10) Pub. No.: US 2005/0125701 A1
(43) Pub. Date: Jun. 9, 2005

(54) Method and system for energy management via energy-aware process scheduling

(75) Inventors: Eric Van Hensbergen, Austin, TX (US); Ramakrishan Rajamony, Austin, TX (US); Freeman Leigh Rawson III, Austin, TX (US)

Correspondence Address: Andrew M. Harris;Weiss, Moy & Harris, P.C., 4204 North Brown Ave., Scottsdale, AZ, 85251-3914, US

(73) Assignee: International Business Machines Corporation, Armonk, NY (US)

(21) Appl. No.: 10/727,318

(22) Filed: Dec. 3, 2003

(51) Int. Cl. G06F 1/26

(52) U.S. Cl. 713/320

(57) ABSTRACT

A method and system for energy management via energy-aware process scheduling provides per-process energy use/power dissipation control to manage system energy requirements and thermal conditions without throttling overall system performance. Use of energy by a particular process is measured or is estimated from resource requirements that are determined by the operating system or reported by the application owning the process. The scheduler then determines whether or not to allocate execution slices to the process in conformity with the measured or estimated energy requirements of the process. The scheduler may insert “idle” execution slices to reduce energy use/power dissipation or may prefer low energy-use processes over high energy-use processes. Pragmatic faults may be issued as warnings from the operating system to an application to indicate that energy requirements need to be curtailed. If the warning sent to the application does not result in sufficient energy use/power dissipation reduction, then the scheduler may implement the selective allocation of slices to processes that have an excessive energy requirement. The scheduler may be notified of such a condition through pragmatic “critical” faults that indicate a higher degree of severity than the previously-issued warning faults.

### CROSS-REFERENCE TO RELATED APPLICATIONS

The present application is related to previously-filed co-pending U.S. patent application Ser. No. 10/______, attorney docket No. AUS920030761US1 entitled “METHOD AND SYSTEM FOR POWER MANAGEMENT INCLUDING DEVICE CONTROLLER-BASED DEVICE USE EVALUATION AND POWER-STATE CONTROL”, the specification of which is herein incorporated by reference.

### BACKGROUND OF THE INVENTION

1. Technical Field

The present invention relates generally to energy management in processing systems, and more particularly, to a energy management scheme that provides energy management via intelligent process scheduling.

2. Description of the Related Art

Present-day computing systems include sophisticated energy-management schemes for a variety of reasons. For portable computers such as “notebook”, “laptop” and other portable units including personal digital assistants (PDAs), the primary energy source is battery power. Intelligent energy management extends battery life, and therefore the amount of time that a user can operate the system without connecting to a secondary source of power. Energy management has also been implemented over “green systems” concerns so that power dissipated within a building is reduced for reasons of energy conservation and heat reduction.

Recently, energy management has become a requirement in line power connected systems, particularly high processing power cores and systems because the components and/or systems are now designed with total possible energy consumption levels that either exceed power dissipation limits of individual integrated circuits or cabinets, or the total available power supply is not designed to be adequate for operation of all units simultaneously. For example, a processor may be designed with multiple execution units that cannot all operate simultaneously due to either an excessive power dissipation level or a problem in distributing the requisite current level throughout the processor without excessive voltage drop. Or, a memory subsystem may permit installation of more memory than the system energy budget/dissipation budget will allow, in order to accommodate large disk/server caches, scientific data arrays and the like without having to include power distribution that can support the maximum installable memory operating at full power, since the entire memory is not generally active at all times and portions of the memory array can be put in a power-savings mode.

However, the loads imposed on the system vary by process and the associated application(s). Typically, the operating system or system processors will “throttle” performance on a universal basis, if energy use/power dissipation in a system exceeds an allowable threshold, leading to a drastic reduction in performance. Schemes have been proposed to indicate to a process/application that energy use reduction is required, so that energy consumption/power dissipation may be reduced without throttling overall system performance. However, not all applications are responsive to such requests, and therefore energy management cannot be completely effected throughout a system when a process for such an application is running. Additionally, prior systems have been targeted toward “deadline” based energy management. Background tasks that do not require immediate execution are typically scheduled without consideration as to energy availability or the thermal state of the system.

It is therefore desirable to provide a method and system for providing energy management within a processing system that can reduce energy consumption by managing processes so that a high degree of system performance can be maintained while energy consumption/power dissipation is reduced.

### SUMMARY OF THE INVENTION

The objective of reducing energy consumption/power dissipation while maintaining a high degree of system performance is accomplished in a method and system that provide intelligent scheduling of processes in conformity with a measured level of energy use by each process.

The method and system provide an operating system scheduler that determines whether or not to allocate an execution slice to a particular process in conformity with a measured energy use for the particular process. The energy use may be determined by reading performance counters that indicate device activity during prior execution slices allocated to the particular process, or by receiving energy requirement (resource requirement) information for the particular process from the operating system or from the application owning the process. Alternatively, the system may measure actual energy use for the overall system or for multiple devices within the system for each process and the scheduler may schedule execution of slices to the process in conformity with the measured energy use.

Pragmatic faults may be provided by the operating system, hardware, or by a combination of hardware and software to warn an application that energy consumption/power dissipation needs to be reduced, thereby permitting the applications executing on the system to reduce their energy requirements and the scheduler can act when the warnings to the application do not result in sufficient energy requirement reduction. The scheduler may insert idle slices to reduce overall energy use/power dissipation and/or may schedule particularly high-energy-consuming processes less frequently in order to reduce overall system energy consumption/power dissipation.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1 is a block diagram of a computing system in accordance with an embodiment of the invention.

FIG. 2 is a block diagram depicting control and information flow within a system in accordance with an embodiment of the present invention.

FIG. 3 is a flowchart depicting a method in accordance with an embodiment of the present invention.

### DESCRIPTION OF ILLUSTRATIVE EMBODIMENT

The present invention concerns primarily energy management enforced by the operating system scheduler, but also concerns the use of pragmatic faults to inform an application of the need to reduce energy use within a processing system. A warning is issued to an application and the application, if so designed, reduces its resource requirements (or in the case of a background task may re-schedule) in order to permit the system to conserve energy. For example, if an application is using large memory arrays that are statically allocated and otherwise might use dynamic allocation to reduce the size of the arrays, the application can reduce the size of the static allocation in response to an issued warning, in order to permit the system to place a larger number of memory modules in a energy-saving state. Similarly, if the application is using the processor to perform, for example, a floating point intensive real-time display of a result of a computation that is not actually required, the application could stop display generation or reduce the level of floating point computation involved in order to reduce energy consumption of the associated processor(s).

The faults used to issue the warnings described above are pragmatic faults that have associated information structures that represent both degree of fault and additional information about the fault. The faults also can be handled by privileged software that may be at the application level or operating system level via registration with the fault management code. At the application level, registration may be in the form of exception “catching” as supported in languages such as C++ or JAVA. Alternatively, or in concert, standard operating system mechanisms such as “signals” may be used to communicate the pragmatic fault information, which make the fault information accessible to program code written in “C” or other programming languages that do not otherwise support exception handling.

If the above-described application warnings are not effective, which may be caused by applications running on the system that are not designed to reduce their resource requirements in response to the reported faults or applications that are unable to reduce energy usage sufficiently, the operating system scheduler removes execution slices from one or more processes in order to reduce the system energy requirements, or blocks certain processes altogether. The activation of selective scheduling by the scheduler may be made by a fault having a higher level of severity—e.g., a critical pragmatic fault. The scheduler may use information provided either by the application owning a process or by information gathered by the operating system about the process in order to decide whether or not to schedule a process. For example, performance measurements may determine a level of activity for various processing system units or may note resources used (e.g., memory allocation as mentioned above) in order to determine how often and/or whether to schedule an execution slice for a given process. The above-incorporated patent application details methodologies and structures that include per-process performance/usage counters that can be used within the present invention to provide valuable information about per-process use of resources. However, it is not strictly necessary to gather or use performance measurements to control whether or not the scheduler schedules a particular process, as a priori energy use information for the process may be available, the system may determine energy use based on resource usage by the application, or the system may have information about the type of process that suggests that execution of the process may be postponed or canceled (e.g., the system is aware that a process is a non-critical background process such as a virus scanner).

As another strategy to reduce system energy consumption, the scheduler may insert idle process slices into the overall execution stream. In general, while it would be preferable to always schedule a process at every execution slice to avoid a reduction in processing system use, it may be more effective to insert idle slices in situations where continuous allocation of execution slices to any extant process will result in system energy consumption/power dissipation exceeding an allowable threshold. The scheduler may also block allocation of execution slices for one or more processes until system conditions can support execution. For example, if a background process such as a virus scanner or disk indexing service is scheduled for execution, the scheduler may block execution of the process until more overall energy is available to the system or other applications have completed execution, freeing available system energy for execution of the background process.

The scheduler may also be informed of the current system energy-management states via pragmatic faults. For example, if a resource is off-line due to placement in a energy-saving state and the system cannot support activating the resource in the present available energy or thermal condition, then a check of the resource or attempt to make the resource active can return a pragmatic fault indicating the current resource condition. In response, the scheduler can selectively not allocate one or more execution slices to a process that requires the unavailable resource. Fault pairs can be used to signal a later return of the resource to an available state, so that an initial pragmatic fault that causes the scheduler not to execute a particular process can be followed by a second pragmatic fault that indicates the resource has come on-line and the scheduler can schedule processes that were previously blocked due to unavailability of the resource.

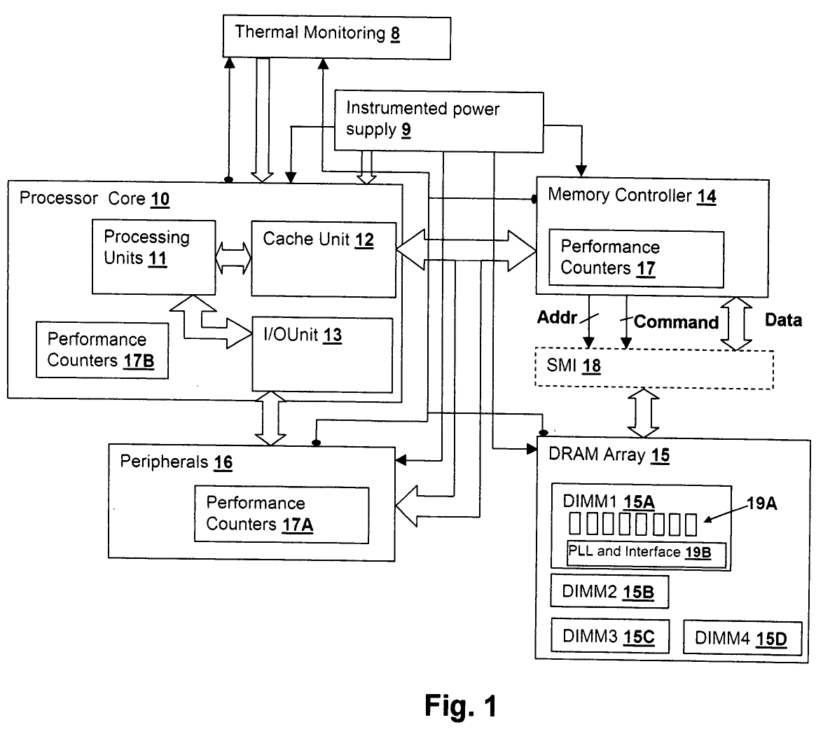

With reference now to the figures, and in particular with reference to FIG. 1, there is depicted a block diagram of a computer system in which the present invention is practiced. A processor core 10 includes multiple processing units 11 coupled to an I/O unit 13 that provides for communication with peripherals 16 and device controllers such as memory controllers 14. Processor core 10 also includes one or more cache units 12 that generally provide the memory interface to memory controller 14. Memory controller 14 is coupled to a dynamic random-access memory (DRAM) array 15 and provides control signals in the form of address lines and command strobes. In larger systems, multiple DRAM arrays 15 may be coupled to memory controller 14 by one or more Synchronous Memory Interfaces (SMIs) 18 which provide partitioning of the memory subsystem into large banks.

By way of illustration, the memory subsystem energy management possibilities will be described in detail, but it should be understood that the techniques of the present invention extend to any resource used by an application, where a decreased usage level will result in the reduction of system energy usage levels and/or reduced power dissipation. DRAM array 15 includes multiple dual in-line memory modules (DIMMs) 15A-15D, each of which can be energy-managed separately by the operating system via memory controller 14. Other energy-management granularity is possible, such as powering down banks within DIMMs 15A-15D, if bank-level energy management is possible. However, in general, energy management at present is generally performed at the DIMM level. DIMMs 15A-15D each include memory devices 19A and interface circuits 19B that include a phase-lock loop (PLL) for synchronizing the memory device 19A with the DIMM bus interface to SMI 18 or memory controller 14. The energy management states available for setting within DIMMs 15A-15D, vary based on design, but generally a standby state, a power down mode, and a self-refresh state are available. In the self-refresh state, the external PLL within interface circuits 19B can be disabled, along with other circuits that consume energy that do not need to be enabled when a particular DIMM is in a self-refresh state (such as control registers and performance/use counters). The operating system can control the energy management states of each of DIMMS 15A-D on a per-execution-slice basis, with an introduction of some latency associated with the energy management and any changes or power-management state. Therefore, if system energy requirements or thermal states exceeding allowable limits are detected within the memory array, processes that require the active states of more DIMMs 15A-D modules than can be simultaneously supported (under the present operating conditions) can be blocked, and/or processes that require the largest number of active DIMMs 15A-D can at least be scheduled less often.

In order to determine which processes are the greatest contributors to system energy requirements/power dissipation, performance counters can be used to determine activity of various devices and units in the system on a per-process basis. Performance counters 17B measure the use of various units within processor core 10, including floating point unit, fixed point unit and cache controller activity. Each level of activity can be correlated with an energy consumption and also potentially with a power dissipation amount. An estimate of the overall energy use by a given process can then be made in conformity with the measured activity levels. Peripherals 16 also include performance counters 17A and memory controller 14 includes performance counters 17, providing measures of activity connected devices. Alternatively, the actual energy consumption of the system may be measured, generally by measuring the output current of individual power supplies 9 or the total current consumed by the system. Or, thermal monitors 8 may be employed to determine temperatures of various devices if the intent is to control the system for thermal failure or thermal output. Generally, the determination of per-process power dissipation is not possible via thermal measurement, as the thermal time constants are generally much larger than the execution time slice within a machine. However, it may be possible with larger time slices or more responsive monitors to determine changes, or by observing thermal increase as an application is activated, and if suitable information about power dissipation caused by a particular process can be determined, then the information can be used to provide decision-making input to the system scheduler.

Another mechanism that may be used as input for the scheduler to determine which processes are consuming/dissipating the most power is by resource allocation. Generally, the operating system has usable information such as memory allocation for each process, disk pages and open files that are associated with each process, that can be used to predict power consumption due to the execution of the process. Additionally, the application may register resource requirements with the operating system or may be polled to report resource requirements, which may be provided on a per-process basis. The application may also determine its own energy usage by sampling performance counters and/or energy monitors in order to obtain energy requirement information.

Any of the above-described mechanisms may be used, or any combination thereof. Once the information is available to the operating system on which processes have the highest energy requirements, the operating system scheduler can reduce energy consumption (and power dissipation) by selectively scheduling execution slices to the processes running on the system.

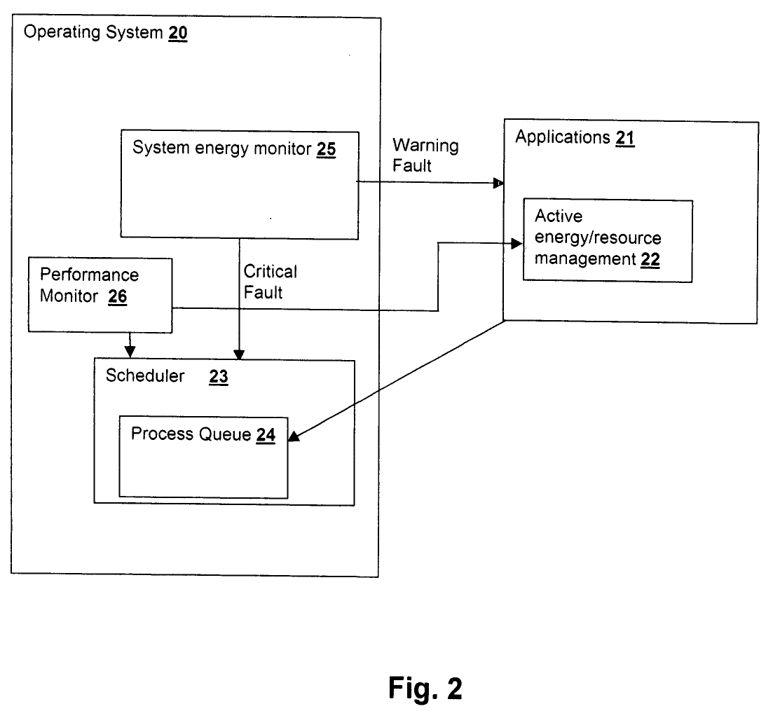

Referring now to FIG. 2, a block diagram depicting the relation of program modules in the present invention is shown. A system energy monitor 25 within operating system 20 determines when a reduction of energy use is becoming necessary or is desirable, for example, when battery energy is low, when thermal conditions indicate impending failure, when the workload is much less than the current capacity of the system, etc. System energy monitor 25 provides indications of system energy availability, energy use and/or system thermal state(s) and a system performance monitor 26 provides indications of system energy use based on events that are counted. Both sources of input are used to determine when to notify the operating system and applications when energy used might be reduced (due to under-utilization of powered resources) or must be reduced (due to impending thermal overload or limited energy budget).

Applications 21 receive pragmatic warning faults from the operating system as indicated by system energy monitor 25 and/or system performance monitor 26, and if an application is designed to manage its energy usage, an active energy/resource management code 22 acts to reduce the application's energy usage. If energy usage is not reduced sufficiently when requested, system energy monitor 25 sends a critical fault indication to a scheduler 23 that oversees the queuing of execution slices to various processes by managing a process queue 24, that queues processes supporting applications 21. Scheduler 23 receives input from the system performance monitor 26, which maintains the information on activity level for each process as obtained from the performance counters described above. Alternatively, scheduler 23 may queue processes for slice allocation on a selective basis (in conformity with their energy requirements), rather than removing or blocking slice allocation for already queued processes.

The embodiment of the invention depicted in FIG. 2 is an embodiment estimating energy usage for each process from activity levels. Other embodiments will provide other operating system 20 module corresponding to the usage measurement techniques employed as described above. (E.g., system energy monitor code, thermal monitoring code, resource managers, etc.) Scheduler 23 uses the performance monitor information 26 to selectively decide whether or not to allocate the next execution slice to the next process queued in process queue 24. Scheduler 23 may either prefer a process over another or may insert idle process slices (sometimes an actual process referred to as “system idle process”).

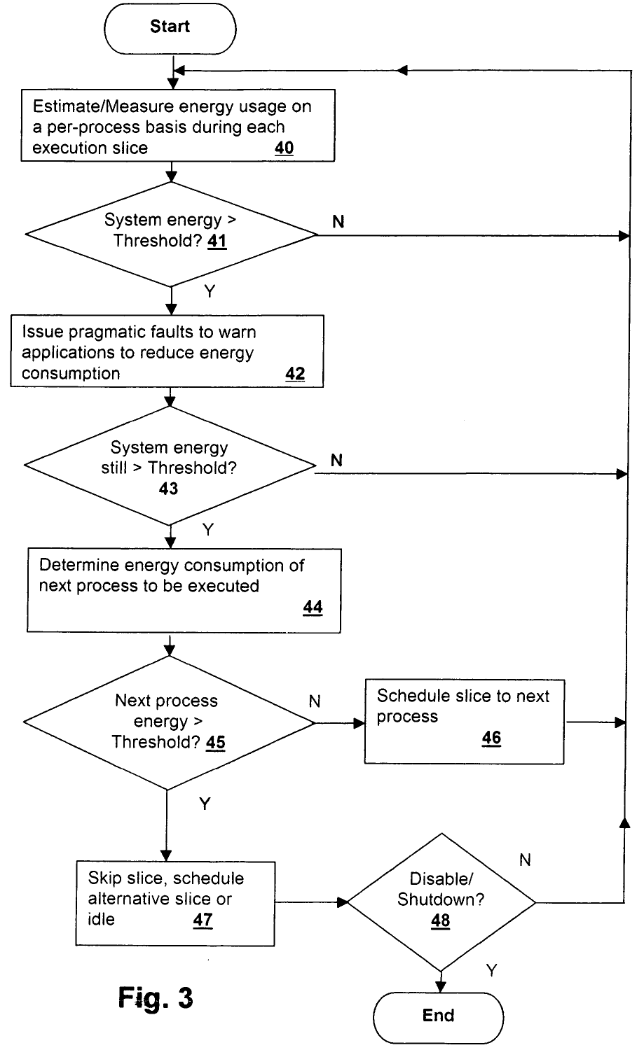

Referring now to FIG. 3, a flowchart depicting a method in accordance with an embodiment of the invention is shown. First, energy usage is estimated or measured on a per-process basis via activity counts, resource use, energy measurements and/or thermal profiles as described above (step 40) as processes are executed on the system. If the system energy use exceeds an allowable threshold (decision 41), then pragmatic faults are issued to the applications to reduce their energy requirements (step 42). If the system energy is still above the threshold after the applications have had time to respond (decision 43), then the scheduler begins to manage system energy use. The scheduler determines the estimated energy consumption of the next process to be scheduled (step 44) and if the energy level is over a threshold (step 45), then the process is not allocated the next slice. The slice is either skipped for the next process in the queue, an alternative process is scheduled or an idle slice is inserted (step 47). If the energy consumption for the next slice was under the threshold (step 45), the scheduler grants the slice to the next process (step 46) as is usual. The above procedure is repeated until scheduler energy-management is disabled or the system is shut down (step 48).

While the invention has been particularly shown and described with reference to the preferred embodiment thereof, it will be understood by those skilled in the art that the foregoing and other changes in form, and details may be made therein without departing from the spirit and scope of the invention.

1. A method of managing energy in a processing system, comprising:
receiving an indication of a need to reduce a energy usage level in said processing system at a scheduler;
determining whether or not a next process to be scheduled has an associated level of energy usage greater than a threshold; and
selectively scheduling an execution slice for said next process in response to determining that said associated level of energy usage does not exceed said threshold.

2. The method of claim 1, further comprising:
reading values of a plurality of performance counters during one or more previous execution slices of said next process; and
estimating said associated level of energy usage in conformity with said values of said plurality of performance counters.

3. The method of claim 1, further comprising:
measuring actual energy usage of said processing system during or more previous execution slices of said next process; and
estimating said associated level of energy usage in conformity with said measured energy usage.

4. The method of claim 1, further comprising:
second determining a resource usage of said next process; and
estimating said associated level of energy usage in conformity with said resource usage.

5. The method of claim 4, further comprising receiving from an application owning said next process an indication of said resource usage, and wherein said second determining determines said resource usage in conformity with said received indication.

6. The method of claim 4, wherein said second determining is performed by said operating system by observing prior allocation of resources to said next process.

7. The method of claim 1, further comprising:
issuing a pragmatic warning fault indicating that a system energy usage above a system energy threshold; and
second receiving said pragmatic warning fault at an application associated with said next process, and in response to said second receiving, reducing a resource usage within said application, whereby a energy usage of said next process is reduced.

8. The method of claim 7, further comprising:
issuing a critical pragmatic fault indicating that said system energy usage has not been reduced below said system energy threshold; and
receiving said critical pragmatic fault at said scheduler, and wherein said selectively scheduling is performed in response to said receipt of said critical pragmatic fault by said scheduler.

9. The method of claim 1, wherein said selectively scheduling inserts idle slices into an execution queue, whereby said energy usage level is reduced.

10. The method of claim 1, wherein said selectively scheduling schedules a second process having a lower level of energy usage than said next process in preference over said next process.

11. A processing system, comprising:
a processor;
a memory coupled to said processor for storing program instructions and data values, and wherein said program instructions comprise an operating system scheduler that includes program instructions for
receiving an indication of a need to reduce a energy usage level in said processing system at a scheduler,
determining whether or not a next process to be scheduled has an associated level of energy usage greater than a threshold, and
selectively scheduling an execution slice for said next process in response to determining that said associated level of energy usage does not exceed said threshold.

12. The processing system of claim 11, wherein said program instructions further comprise program instructions for:
reading values of a plurality of performance counters during one or more previous execution slices of said next process; and
estimating said associated level of energy usage in conformity with said values of said plurality of performance counters.

13. The processing system of claim 11, wherein said program instructions further comprise program instructions for:
measuring actual energy usage of said processing system during or more previous execution slices of said next process; and
estimating said associated level of energy usage in conformity with said measured energy usage.

14. The processing system of claim 11, wherein said program instructions further comprise program instructions for:
second determining a resource usage of said next process; and
estimating said associated level of energy usage in conformity with said resource usage.

15. The processing system of claim 14, wherein said program instructions further comprise program instructions for receiving from an application owning said next process an indication of said resource usage, and wherein said determining determines said resource usage in conformity with said received indication.

16. The processing system of claim 14, wherein said program instructions for second determining further comprise program instructions for observing prior allocation of resources to said next process.

17. The processing system of claim 11, wherein said program instructions further comprise program instructions for:
issuing a pragmatic warning fault indicating that a system energy usage above a system energy threshold; and
receiving said pragmatic warning fault at an application associated with said next process, and in response to said receiving, reducing a resource usage within said application, whereby a energy usage of said next process is reduced.

18. The processing system of claim 11, wherein said program instructions further comprise program instructions for:
issuing a critical pragmatic fault indicating that said system energy usage has not been reduced below said system energy threshold; and
receiving said critical pragmatic fault at said scheduler, and wherein said selectively scheduling is performed in response to said receipt of said critical pragmatic fault by said scheduler.

19. The processing system of claim 11, wherein said program instructions for selectively scheduling insert idle slices into an execution queue, whereby said energy usage level is reduced.

20. The processing system of claim 11, wherein said program instructions for selectively scheduling schedule a second process having a lower level of energy usage than said next process in preference over said next process.

21. A computer program product comprising signal-bearing media encoding program instructions and data, wherein said program instructions comprise an operating system scheduler that includes program instructions for
receiving an indication of a need to reduce a energy usage level in said processing system at a scheduler,
determining whether or not a next process to be scheduled has an associated level of energy usage greater than a threshold, and
selectively scheduling an execution slice for said next process in response to determining that said associated level of energy usage does not exceed said threshold.

22. The computer program product of claim 21, wherein said is program instructions further comprise program instructions for:
reading values of a plurality of performance counters during one or more previous execution slices of said next process; and
estimating said associated level of energy usage in conformity with said values of said plurality of performance counters.

23. The computer program product of claim 21, wherein said program instructions further comprise program instructions for:
measuring actual energy usage of said processing system during or more previous execution slices of said next process; and
estimating said associated level of energy usage in conformity with said measured energy usage.

24. The computer program product of claim 21, wherein said program instructions further comprise program instructions for:
second determining a resource usage of said next process; and
estimating said associated level of energy usage in conformity with said resource usage.

25. The computer program product of claim 24, wherein said program instructions further comprise program instructions for receiving from an application owning said next process an indication of said resource usage, and wherein said determining determines said resource usage in conformity with said received indication.

26. The computer program product of claim 24, wherein said program instructions for second determining further comprise program instructions for observing prior allocation of resources to said next process.

27. The computer program product of claim 21, wherein said program instructions further comprise program instructions for:
issuing a pragmatic warning fault indicating that a system energy usage above a system energy threshold; and
receiving said pragmatic warning fault at an application associated with said next process, and in response to said receiving, reducing a resource usage within said application, whereby a energy usage of said next process is reduced.

28. The computer program product of claim 21, wherein said program instructions further comprise program instructions for:
issuing a critical pragmatic fault indicating that said system energy usage has not been reduced below said system energy threshold; and
receiving said critical pragmatic fault at said scheduler, and wherein said selectively scheduling is performed in response to said receipt of said critical pragmatic fault by said scheduler.

29. The computer program product of claim 21, wherein said program instructions for selectively scheduling insert idle slices into an execution queue, whereby said energy usage level is reduced.

30. The computer program product of claim 21, wherein said program instructions for selectively scheduling schedule a second process having a lower level of energy usage than said next process in preference over said next process.
